(19) United States
(12) Patent Application Publication
(10) Pub. No.: US 2013/0186864 A1
(43) Pub. Date: Jul. 25, 2013

(54) DEVICE FOR CONTINUOUSLY MANUFACTURING PIPES OF METAL

(71) Applicants: Ralf Egerer, Seesen (DE); Holger Schulz, Hannover (DE)

(72) Inventors: Ralf Egerer, Seesen (DE); Holger Schulz, Hannover (DE)

(21) Appl. No.: 13/558,705

(22) Filed: Jul. 26, 2012

(30) Foreign Application Priority Data
Sep. 15, 2011 (EP) 11 290 412.3

(51) Int. Cl. B23K 28/00

(52) U.S. Cl. CPC B23K 28/00
USPC 219/59.1

(57) ABSTRACT

A device for continuously manufacturing pipes of metal, wherein the device includes a shaping unit (4) for shaping a pipe with a slot extending in the longitudinal direction from a longitudinally arriving metal strip, a welding device (7) for welding the contacting edges of the metal strip at the slot of the pipe, and a pulling device for pulling the pipe (9) which is now circumferentially closed in its longitudinal direction. The welding device (7) is composed of at least two separate welding heads (12,13) arranged in the pulling direction of the pipe (9) at a distance from each other, wherein the welding heads (12,13) each have at least one non-burning electrode.

### RELATED APPLICATION

This application claims the benefit of priority from European Patent Application. No. 11 290 412.3, filed on Sep. 15, 2011, the entirety of which is incorporated by reference.

### BACKGROUND

1. Field of the Invention

The invention relates to a device for continuously manufacturing pipes of metal, wherein the device includes a shaping unit for shaping a pipe with a slot extending in the longitudinal direction from a longitudinally arriving metal strip, a welding unit for welding the edges of the metal strip which are in contact at the slot of the pipe, and a pulling unit for pulling the pipe, which is circumferentially closed after welding, in the longitudinal direction. (EP 1 604 768 B1)

2. Description of the Related Art

Devices of this type are used for continuously manufacturing pipes of different metals. The pipes are, for example, of steel, particularly high grade steel, copper or a copper alloy, as well as aluminum or an aluminum alloy. Such pipes, which after welding can also be provided with an undulation extending transversely of the longitudinal direction, are used, for example, for transporting fluids. However, they can also be utilized as protective pipes of electrical and/or optical cables, as conductors of high frequency cables or for cryostats for superconductive cables through which a very cold medium is conducted.

In the known device according to the above mentioned EP 1 604 768 B1, a metal strip is pulled from a strip supply and is conveyed to a shaping device provided with shaping cones or shaping rollers. In the shaping device, the strip is shaped into a pipe having a slot extending in the longitudinal direction at which the two edges of the strip contact each other. The slot is subsequently welded in a welding device with continuous feed under protective gas, so that a circumferentially closed pipe is obtained. A welding method used for this purpose, for example, is the TIG method (Tungsten Inert Gas). In this device the welding device is a welding head with two non-burning electrodes, which are directed with appropriate spatial association to the same welding point. The welding seam manufactured in the welding device is produced by the material of the metal strip itself, which is transposed into the liquid melted state by the electrode being used. Always only one electrode is in use. When an electrode is used up, a switch is made to the other electrode, which up to then has been in a waiting position. The used electrode can then be exchanged without interrupting the operation. The use of this device is limited to relatively low maximum voltages as they are used for commercially available electrodes.

### OBJECTS AND SUMMARY

It is the object of the invention to further develop the above described device in such a way that it can be used for welding metal strips of any material of any thickness, even at higher voltages.

In accordance with the invention, this object is met in that the welding device is composed of at least two separate welding heads spaced apart in the pulling direction of the pipe, wherein each welding head has at least one non-burning electrode.

This device can be used variably for different voltages, so that metal strips of different materials and with different wall thicknesses can be welded. This makes possible, independently of the number of electrodes utilized per welding head, an interruption free continuous manufacture. Each of the welding heads may be used with only one electrode or, with increased voltages, with two electrodes directed toward the same welding point, or in the case of an even further increased voltage, with three electrodes which are also directed at the same welding point. When the electrode or electrodes of one welding head is or are used up, the operation of the other welding head is started. This is to be done in sufficient time so that the continuous manufacture does not have to be interrupted. In that case, the welding seam closing the slot of the pipe may possibly be duplicated along a variable length. However, this does not constitute a problem, but rather increases the certainty that the welding seam is tightly closed.

### BRIEF DESCRIPTION OF THE DRAWINGS

An embodiment of the subject matter of the invention is illustrated in the drawing.

In the drawings:

FIG. 1 schematically shows a device according to the invention for continuously manufacturing pipes.

FIG. 2 is a sectional view through FIG. 1 along the dash-dot line II in an enlarged illustration.

FIG. 3 is a sectional view through FIG. 1 along the dash-dot line III also in an enlarged illustration.

FIG. 4 shows a welding device for use in the device according to FIG. 1.

### DETAILED DESCRIPTION

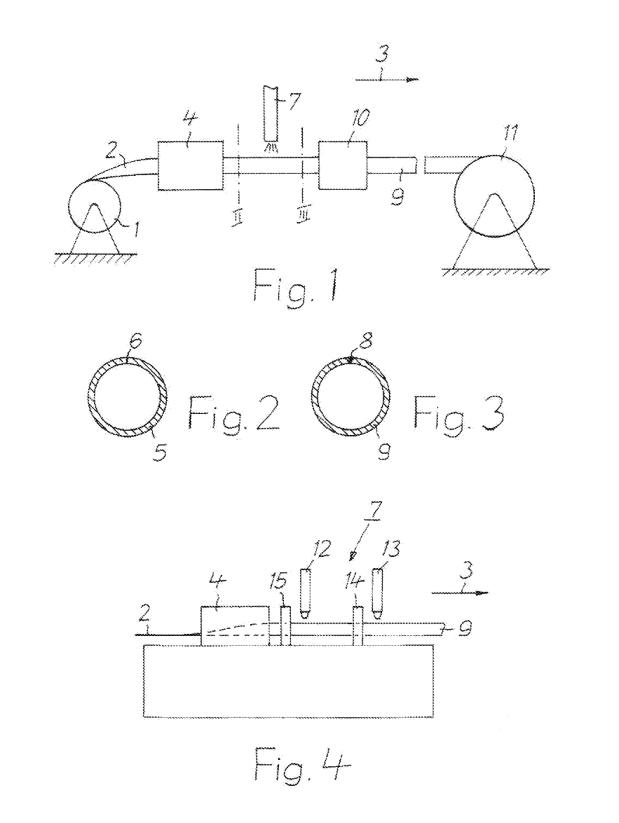

In accordance with FIG. 1 a metal strip 2, for example, of high grade steel, is pulled from a coil 1 in the direction of arrow 3 and is fed to a shaping unit 4. In the shaping unit 4 which is known per se, for example, shaping rollers may be included by means of which the longitudinally arriving metal strip 2 is shaped into a pipe 5 having a slot 6 extending in its longitudinal direction where the two edges of the metal strip 2 contact each other (FIG. 2).

The pipe 5, which is still open at the slot 6, then travels through a welding unit 7 in which the slot 6 is closed by welding seam 8, so that a circumferentially closed pipe 9 is formed. The pipe 9 is pulled by means of a puling device 10 in the direction of arrow 3. It can finally be wound onto a coil 11.

The construction of the welding device 7 is shown in a more detailed illustration in FIG. 4, for example, in a preferred embodiment having two welding heads:

The welding device 7 schematically illustrated in FIG. 4 has two welding heads 12 and 13, which are arranged separately of each other in the pulling direction of the pipe 9 indicated by arrow 3. In the pulling direction in front of the second welding head 13 is arranged a shaping step 14 which holds together the edges of the metal strip 2, if necessary, up to the welding point. It corresponds to a shaping step 15 belonging to a shaping unit 4 which is mounted in the pulling direction in front of the welding head 12.

Each of the welding heads 12 and 13 may be equipped with only one electrode. However, it is also possible to utilize two or more electrodes which are each directed with their welding heads toward the same welding point. For example, a welding head operating with two electrodes is shown in the above mentioned EP 1 604 768 B1. A welding head with three electrodes is described, for example, in DE-A-2 156 851.

If, for safety reasons, in another embodiment of the welding device, a third welding head is utilized, then preferably also a shaping step corresponding to the shaping step 14 is arranged in front of the third welding head.

The device according to FIG. 1 operates, for example, as follows:

After switching on all necessary units of the device, the metal strip 2 is pulled from the coil 1 and is shaped in the shaping unit 4 into the pipe 5 with the slot 6 still being open. In this connection, the term “open” refers to the fact that the slot 6 has not yet been closed by a welding seam. However, the two edges of the metal strip 2 are bent in such a way that they always contact each other at the slot 6, for example, by abutting. Subsequently, the slot 6 of the pipe 5 is closed by means of the initially active welding head 12 independently of the number of its electrodes. The welding head 12 remains switched on until its electrode is used up and must be replaced by a new electrode. The term “electrode” also includes the term “electrodes” if more than one electrode has been utilized per welding head. In time before the electrode of the welding head 12 must be replaced, the welding head 13 is switched on which then also produces a welding seam. The welding seam 8 is constructed in duplicate, possibly until the welding head 12 has been switched off.

When the welding head 12 is switched off, its electrode can be replaced by a new one, so that the welding head 12 is once again ready for operation. In analogy to the described method of operation, the welding head 12 is then switched on once again once the electrode of the welding head 13 has been used up and must be replaced. In the manner already described, always one of the welding heads 12 or 13 is alternatingly active, so that a continuous manufacture of the pipe 9 closed by the welding seam 8 is possible, also for very long lengths.

Accordingly, in the case of an uninterrupted operation, the pipe line is continuously closed by a welding seam 8 which, in turn, may also be manufactured in duplicate when both welding heads 12 and 13 are simultaneously switched on over a short period of time. In the event that the welding head 12 has been switched off slightly early before the welding head 13 has been completely activated, the edges of the metal strip 2 at the then still “open” slot 6 are held together by the shaping step 14 in such a way that the welding head 13 can produce a problem-free welding seam 8.

1. Device for continuously manufacturing pipes of metal, the device comprising:
a shaping unit for shaping a pipe having a slot extending in the longitudinal direction from a longitudinally arriving metal strip;
a welding device for welding the edges of the metal strip which contact each other at the slot of the pipe; and
a pulling device for pulling the pipe which is circumferentially closed after welding,
wherein the welding device includes at least two separate welding heads which are arranged in the pulling direction of the pipe at a distance from each other, wherein each welding head includes at least one non-burning electrode.

2. Device according to claim 1, wherein, in front of the welding head, arranged in the pulling direction of the pipe behind the first welding head, a shaping step is arranged which holds together the edges of the metal strip, located at the slot of the pipe, which may still be open.
